(19) United States
(12) Patent Application Publication
(10) Pub. No.: US 2011/0221684 A1
(43) Pub. Date: Sep. 15, 2011

(54) TOUCH-SENSITIVE INPUT DEVICE, MOBILE DEVICE AND METHOD FOR OPERATING A TOUCH-SENSITIVE INPUT DEVICE

(75) Inventor: Tobias RYDENHAG, Malmo (SE)

(73) Assignee: SONY ERICSSON MOBILE COMMUNICATIONS AB, Lund (US)

(21) Appl. No.: 12/721,751

(22) Filed: Mar. 11, 2010

(51) Int. Cl. G06F 3/041

(52) U.S. Cl. 345/173

(57) ABSTRACT

The present invention relates to a touch-sensitive input device for an electronic device, a mobile device and a method for operating a touch-sensitive input device that allow additional and more flexible input operations by a user, such as different input gestures. The touch-sensitive input device for an electronic device comprises a touch-sensitive sensor panel operable to sense a region of said touch-sensitive sensor panel that is touched by a user; and a controller adapted to determine a shape and position of the touched region on said touch-sensitive sensor panel at different times and adapted to trigger a function of the electronic device dependent on the change in shape and position of the touched region with time.

### FIELD OF THE INVENTION

The present invention relates to a touch-sensitive input device for an electronic device, a mobile device and a method for operating a touch-sensitive input device. In particular, the touch-sensitive input device may be used as user interface for controlling various functions of an electronic device, such as a mobile device.

### BACKGROUND

Different kinds of sensors serving as user interfaces in devices, such as mobile devices, are known in the art for sensing an input action of a user. In touch sensors, the input is performed via touching a sensor surface with a finger or a stylus. Therefore, touch sensors provide a user interface or man-machine interface to control various functions of the device having the touch sensor incorporated therein.

Known touch sensors work by reacting to a change in capacitance, change in resistance or change in inductance effected by a finger or stylus of a user touching the sensor surface. The position sensing capability can be achieved by providing two layers with capacitive or resistive components or elements in the touch sensors. These components are connected with each other horizontally in the first layer and vertically in the second layer to provide a matrix structure enabling to sense a position in x, y-coordinates of where the touch sensor is touched. In capacitive touch sensors, a capacitive component of one layer forms one electrode of a capacitor and the finger or stylus, which has to be conductive, forms another electrode.

In projected capacitive touch sensing, a conductive layer is etched and an x,y-array is formed on a single layer to form a grid pattern of electrodes or is formed on two separate conductive layers.

To measure capacitance, the so-called CapTouch Programmable Controller for Single Electrode Capacitance Sensors AD7147 manufactured by Analog Devices, Norwood, Mass., USA (see data sheet CapTouch™ Programmable Controller for Single Electrode Capacitance Sensors, AD7147, Preliminary Technical Data, 06/07—Preliminary Version F, 2007 published by Analog Devices, Inc), may be used, for example.

Recent applications, such as multi-touch applications require that more than one position on a touch sensor is touched and sensed, e.g. to determine a section of an image on a display that is to be magnified or to trigger a specific function.

Multi-touch is one of several known gestures that are used to control operations of a mobile device, such as a mobile phone, via a touch screen. Several other gestures are known, such as a single tap, often used to select a function, a double tap, often used to magnify a currently viewed section or a flick, often used to turn pages or scroll up or down a text.

Due to the increasing complexity of user interfaces, in particular the functions associated with the user interface, it is important to provide intuitive gestures to control the mobile device via its user interface to simplify operations thereof. On the other hand, the user interface itself has to be able to interpret the gestures performed by the user correctly.

Therefore, it is desirable to provide a touch-sensitive input device, a mobile device and method for operating a touch-sensitive input device allowing additional and more flexible input operations by the user, such as different input gestures.

### DISCLOSURE OF INVENTION

A novel touch-sensitive input device, a mobile device and method for operating a touch-sensitive input device are presented in the independent claims. Advantageous embodiments are defined in the dependent claims.

An embodiment of the invention provides a touch-sensitive input device for an electronic device, comprising a controller as well as a touch-sensitive sensor panel operable to sense a region of the touch-sensitive sensor panel that is touched by a user. The controller is adapted to determine a shape and position of the touched region on the touch-sensitive sensor panel at different times and adapted to trigger a function of the electronic device dependent on the change in shape and position of the touched region with time.

Accordingly, a controller may not only determine a touched position but also the shape of touched regions. Thus, when different gestures are performed by a finger of a user, a change in shape and position of the touched region with time may be determined so that the controller may interpret the gestures correctly. This allows introducing new gestures for performing input operations to an electronic device, wherein the gestures can be assigned to different functions of the electronic device. Therefore, operation of a touch-sensitive input device can be simplified and the amount of functions associated with different gestures can be increased. Further, gesture interpretation can be made reliable.

In one embodiment, the touch-sensitive sensor panel has a plurality of touch-sensitive elements activatable by the user, wherein activated touch-sensitive elements define the shape and position of the touched region. Accordingly, known touch-sensitive sensor panels with capacitive or resistive components arranged in a grid or matrix can be used to provide the touch information for the controller which determines therefrom the shape and position of the touched region to interpret the touch information.

In one embodiment, the touch-sensitive elements comprise at least one of resistive and capacitive touch-sensitive elements. Accordingly, known resistive or capacitive touch-sensitive sensor panels can be used in the touch-sensitive input device or even a combination of both is possible.

In one embodiment, the controller is adapted to determine the center position of the touched region. Accordingly, the shape and the center position can be determined at different times so that a more reliable interpretation of a gesture is obtained.

In one embodiment, the controller is adapted to detect a finger of the user rolling over the touch-sensitive sensor panel by determining an increase in the size and change of position of the touched region with time. Accordingly, a rolling motion of the finger can be detected reliably, wherein the touched region has usually the largest size when the finger lies flat on the touch-sensitive sensor panel. For example, the shape changes and the size of the touched region decreases when the finger rotates 90 degrees to the left or right. Accordingly, also the center position moves slightly to the left or right, respectively. Therefore, a function may be assigned to the detected gesture.

In one embodiment, the controller is adapted to detect a finger of the user increasing pressure on the touch-sensitive sensor panel by determining an increase in the size and change of position of the touched region with time. Accordingly, similar to the above, when pressing the finger harder on the panel, the size of the touched region increases due to the finger being pressed more flat on the panel and the position may slightly move down towards the hand of the user. Therefore, another function can be assigned to this gesture.

In one embodiment, the controller is adapted to detect a finger of the user decreasing pressure on the touch-sensitive sensor panel by determining a decrease in the size and change of position of the touched region with time. Accordingly, when a finger is first pressed against the panel and then pressure is decreased, also the size decreases, i.e. the region touched by the finger on the panel decreases. Similar to the above, a function can be assigned to this gesture.

In one embodiment, the touch-sensitive input device comprises a display device. Accordingly, a touch screen display can be realized by combination with the sensor panel.

In one embodiment, the controller is adapted to control a rotation of a virtual three-dimensional object displayed on the display device dependent on the change in shape and position of the touched region with time. Accordingly, a virtual object can be controlled and rotated based on a rolling finger to mimic the rotation of the finger.

In one embodiment, the controller is adapted to control a selection of a virtual object displayed on the display device dependent on the change in shape and position of the touched region with time. Accordingly, a virtual object may be selected similar to a single click on a desktop of a computer so as to move the selected virtual object.

According to another embodiment, a touch-sensitive input device for an electronic device comprises a touch-sensitive sensor panel operable to sense a region of the touch-sensitive sensor panel that is touched by a finger of the user and a controller adapted to determine a finger rolling motion by the finger of the user on the touch-sensitive sensor panel. Thus, a new gesture for performing an input operation to an electronic device can be assigned to a function of the electronic device.

According to another embodiment, a mobile device is provided comprising one of the above-described touch-sensitive input devices. The mobile device may constitute a mobile phone with a touch screen display. Accordingly, a mobile device may be provided with a novel type of touch-sensitive input device providing a man-machine interface allowing the definition of multiple new gestures.

According to another embodiment, the touch-sensitive input device of an electronic device comprises means for sensing a region of a touch-sensitive sensor panel that is touched by a user, means for determining a shape and a position of the touched region on the touch-sensitive sensor panel at different times and means for triggering a function of the electronic device dependent on the change in shape and position of the touched region with time.

According to another embodiment, a method for operating a touch-sensitive input device of an electronic device is provided. The method comprises the steps of sensing a region of a touch-sensitive sensor panel that is touched by a user, determining a shape and position of the touched region on the touch-sensitive sensor panel at different times, and triggering a function of the electronic device dependent on the change in shape and position of the touched region with time. Accordingly, introducing and interpreting new gestures for performing input operations to an electronic device is possible.

### BRIEF DESCRIPTION OF THE DRAWINGS

FIG. 1a illustrates a touch-sensitive input device and elements thereof according to an embodiment of the invention.

FIG. 1b illustrates another touch-sensitive input device in more detail.

FIG. 2 illustrate a touch-sensitive sensor panel.

FIG. 3a illustrates a finger rolling operation and the effect thereof on the touch-sensitive input device.

FIG. 3b illustrates a selection operation by pressing a finger on the touch-sensitive sensor panel.

FIG. 4 illustrates a flow diagram of a method for operating a touch-sensitive input device according to an embodiment of the invention.

FIG. 5 illustrates a mobile device displaying a virtual three-dimensional object that can be moved by gestures.

### DESCRIPTION OF THE EMBODIMENTS

The further embodiments of the invention are described with reference to the figures and should serve to provide the skilled person with a better understanding of the invention. It is noted that the following description contains examples only and should not be construed as limiting the invention.

In the following, similar or same reference signs indicate similar or same elements.

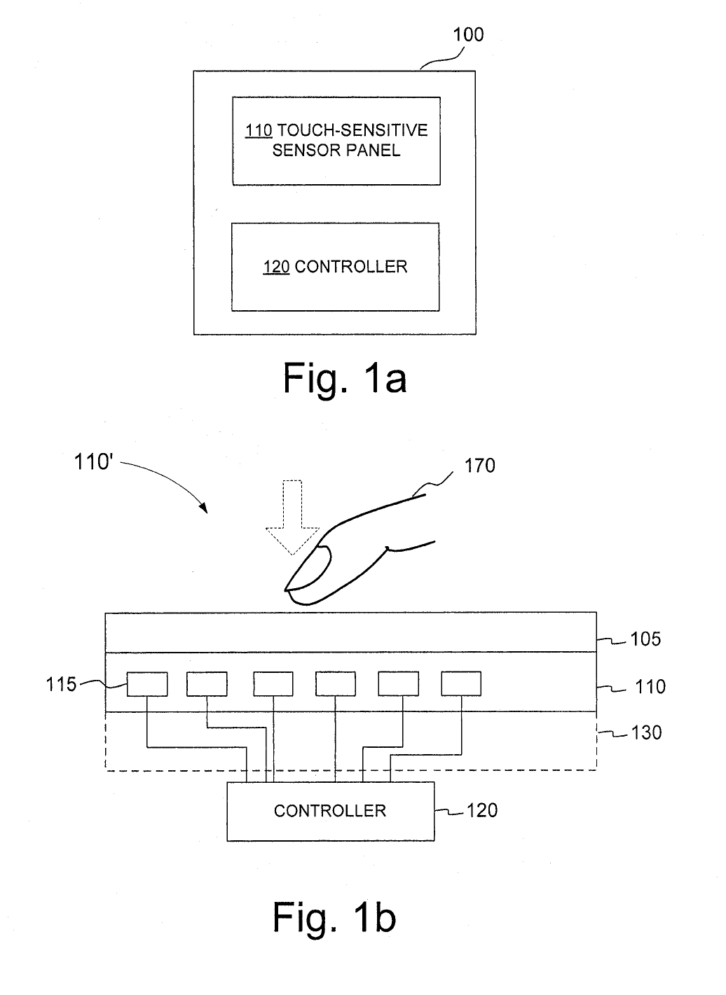

FIG. 1a illustrates elements of a touch-sensitive input device 100 according to an embodiment of the invention. In detail, the touch-sensitive input device 100 comprises a touch-sensitive sensor panel 110 and a controller 120.

The touch-sensitive sensor panel 110 is operable to sense a region of the touch-sensitive sensor panel that is touched by the user. For example, the touch-sensitive sensor panel may be a touch pad or a touch screen and the electronic device may be a mobile phone incorporating the touch-sensitive input device 100 that comprises the touch-sensitive sensor panel 110 and a controller 120. In such a mobile phone, the user may touch the touch-sensitive sensor panel, which will be simply called sensor panel in the following, with his/her finger or other input instrument to operate a menu and trigger functions of the mobile phone.

Several different kinds of sensor panels are known which use capacitive sensing or resistive sensing. It should be understood that touching a region of the sensor panel does not necessarily require pressing with a finger against the panel, since in capacitive sensing, for example, a touch can be sensed by the mere presence of a finger above the sensor panel. In other words, in capacitive sensing it may not be necessary that the sensor panel is actually touched in the meaning of contacting the sensor panel but the finger may just float over the sensor panel with a spacing of 1 mm, for example.

Further, it should be understood that a finger can also be sensed, if the finger does not directly touch the sensor panel. For example, sensor panels with resistive sensing also work when the user wears gloves or if there is a piece of paper or foil between the finger and the sensor panel.

Therefore, the region touched by the user can be very different in size, for example if gloves are used. Further, size differences may also be due to the size of a finger used which is different from person to person and also the type of the finger, since thumb, index finger, middle finger, ring finger and little finger are usually different in size and shape. Further, the touched region may also vary with the pressure exerted by the finger on the sensor panel.

The controller 120 is adapted to determine a shape and position of the touched region on the sensor panel 110 at different times. For example, the controller determines the shape and position of the touched region every 0.2 seconds. Accordingly, a movement of the finger on the sensor panel 110 can be tracked.

In addition to the position which is determined by the controller 120 and can be used for tracking a movement, the controller 120 further determines the shape of the touched region. Accordingly, additional information is obtained which indicates how the user is touching the sensor panel.

For example, a small round shape may indicate that the user's fingertip touches the sensor panel and a larger roughly round shape at a different time, such as 1 second later, may indicate that the fingertip is touching with more pressure so that the fingertip slightly flattens. Furthermore, instead of a larger round shape also a larger oval shape may be detected at a later time indicating that is it not only the fingertip but parts of the upper section, i.e. the nail section, of a finger, e.g. the index finger, which is detected on the sensor panel. In other words, the finger previously on its tip moved partly down on the sensor panel.

Accordingly, a change in shape gives information about the behavior of a finger on the sensor panel, i.e. a gesture performed by the finger on the sensor panel, wherein shape may be understood as the size of a touched region and the type of outline of the region, such as a circular or oval outline. Therefore, parameters may be determined that define size and circular or oval outlines, which are well-known in the art. A parameter for size may be an area in mm² or cm² or the number of touch sensitive elements covered by the finger, as will be described below. A parameter for the circular outline may be the radius r.

Further, the controller 120 is adapted to trigger a function of the electronic device dependent on the change in shape and position of the touched region with time. Accordingly, as discussed above, detecting the shape and position of the small fingertip at time t₁ and detecting the same fingertip at roughly the same position but now touching a larger region at time t₂, indicating that the finger stayed on the sensor panel and the pressure exerted by the user on the sensor panel 110 has increased, may be associated with a function of switching on the keylock of a mobile device, such as a mobile phone.

A more specific example of a touch-sensitive input device including the sensor panel 110 and the controller 120 as well as operations thereof is described with respect to FIG. 1b. The touch-sensitive input device 100′ of FIG. 1b comprises an example of the controller 120 and sensor panel 110 as well as an optional cover layer 105 and display device 130.

Here, the sensor panel 110 has a plurality of touch-sensitive elements 115 activatable by the user, wherein the activated elements define the touched region and its shape.

As known in the art, touch-sensitive elements may constitute a matrix structure, for example an x, y-array forming a grid pattern of electrode elements for capacitive sensing. Electrode elements which can be coated underneath the cover layer 105 and are preferably transparent conductors made of indium tin oxide (ITO) may each form an electrode of a capacitor. Charge is supplied to the electrode element resulting in an electrostatic field, wherein the electric properties are changed when a human finger, e.g. finger 170, provides for a second conductive electrode as a counterpart to form a capacitor. Accordingly, a change in capacitance, i.e. in the electrostatic field, can be measured so that the finger 170 above the electrode element can be detected.

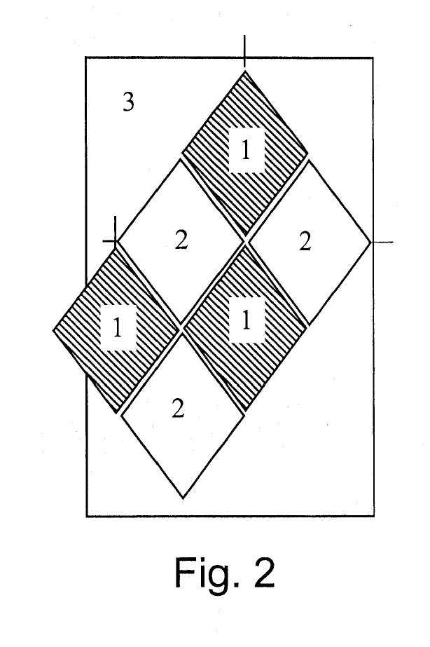

The above example described capacitive touch-sensitive elements. An exemplary arrangement of capacitive touch-sensitive elements is schematically illustrated in FIG. 2. The sensor panel of FIG. 2 includes two layers, a layer labelled “1” and layer labelled “2”. The capacitive elements of layer “1” are connected to each other vertically and the capacitive elements of layer “2” are connected to each other horizontally. The layer labelled “3” is an insulating plane. This arrangement provides a matrix structure enabling to obtain the x and y-coordinates of the position where a user touches the sensor panel.

The shape of the elements is not limited to a diamond shape and several other shapes can be used as touch-sensitive elements, e.g. square or rectangular shapes.

Alternatively, the touch-sensitive elements 115 in FIG. 1b may be resistive touch-sensitive elements.

For example, the resolution/grid of a capacitive sensor panel can be chosen to be 5 mm×5 mm but also smaller elements can be used to achieve a higher resolution for the position and to derive the shape of the touched region more accurately.

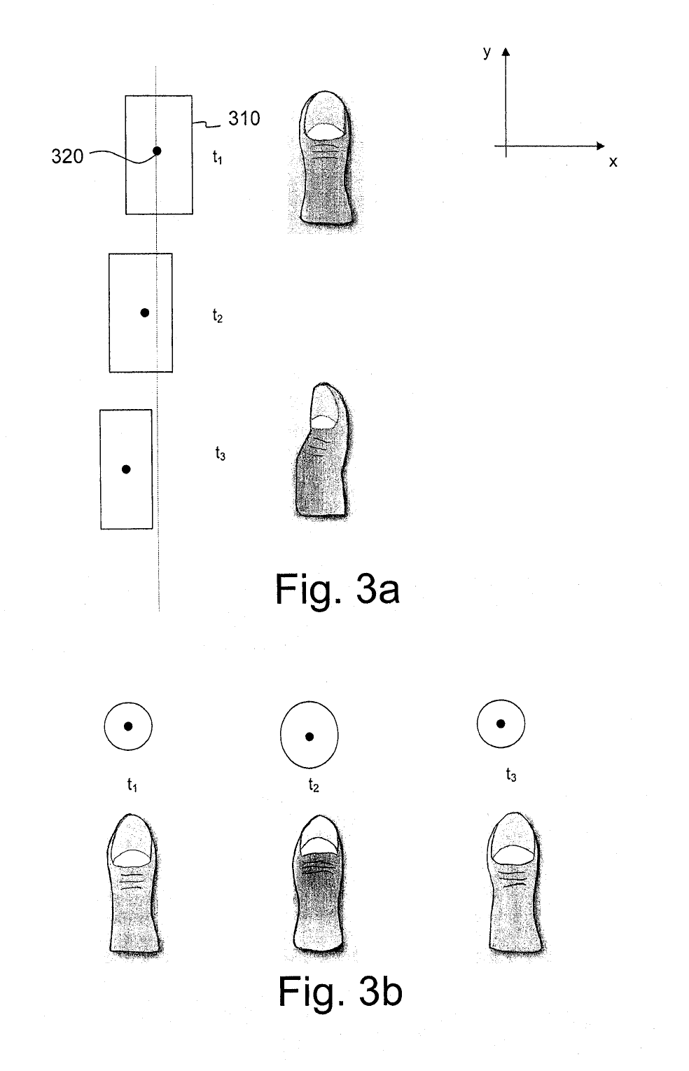

Assuming that the upper section of the thumb is 2 cm×3 cm, a region touched by the thumb thus roughly covers 24 elements. The controller may then determine the center position of the touched region by receiving a signal from the elements touched by the thumb. Since the position in the grid of the elements is known to the controller, the controller may determine the center of these elements. Further, also the shape can be derived from the touched element which may be roughly rectangular with four elements in the width direction (x-direction) and six elements in the length direction (y-direction), an example of which is shown in FIG. 3a.

It is noted that a higher resolution of the position and a better contour of the shape can also be achieved without using smaller touch-sensitive elements, namely by using voltage readings from not only the closest touch-sensitive elements to the finger, i.e. the ones directly covered by the finger but also neighboring elements. By doing this a two-dimensional voltage profile can be determined more accurately with higher resolution.

For example, a finger, such as the thumb, lying flat on the panel, covers roughly 24 touch-sensitive elements indicating a roughly rectangular shape 310 and a center position 320 of the touched region, which are determined at time t₁, shown in FIG. 3a. Then, a change in shape and position of the touched region can be determined at a later time or times by determining shape and position at that time.

For example, as shown in FIG. 3a, a finger is rolling over the sensor panel. In FIG. 3a, the rectangular shape shown at time t₂ indicates the region covered by the thumb being rotated by 45° to the left and at time t₃ indicates the region covered by the thumb after being rotated by 90° to the left.

As can be seen at the different times in FIG. 3a, by rotating the finger over the sensor panel, the rectangular shape moves slightly to the left and changes its size. Namely, when the thumb is rotated by 90° to the left, the left side of the thumb lies on the sensor panel, which is smaller in size than the bottom surface of the thumb, i.e. when the thumb lies flat on the sensor panel. Further, it can be seen that the center position 320 also moves to the left. Therefore, the rolling motion of the finger can be detected by the controller.

Accordingly, the controller is adapted to detect a finger, e.g. the thumb or any other finger, of the user rolling over the touch-sensitive sensor panel by determining a change in the size and position of the touched region with time.

If the thumb is rolled back from its side (position at time t₃) to the left by 90° to its initial position previously described as position at t₁, a similar shape and position as the one of the time t₁ shown in FIG. 3a is determined. Accordingly, the gesture of rolling a thumb over a sensor panel can be detected by the touch-sensitive input device, namely by the controller determining the shape and position of the touched region at different times.

Further, the controller 120 may be programmed to associate a gesture, such as rolling a thumb over the sensor panel, with a function that is to be carried out in the electronic device comprising the touch-sensitive input device 100, 100′. For example, the gesture can be used to operate a menu shown by the display device 130.

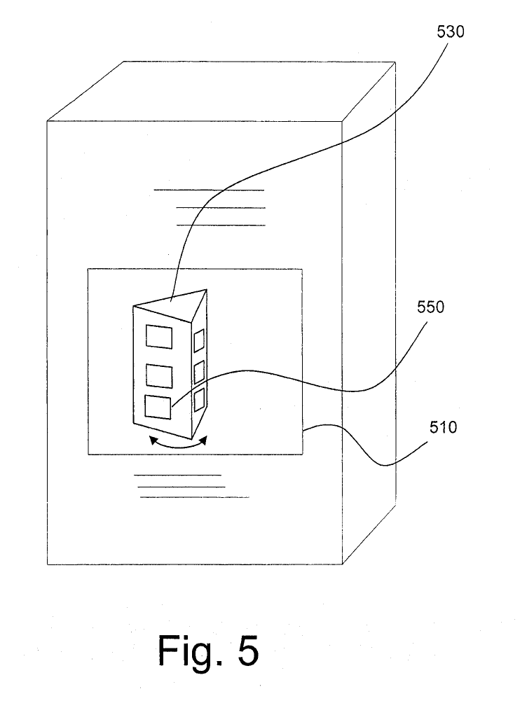

For example, the display device 130 may display a virtual three-dimensional object such as the one shown in FIG. 5. In this example, the controller is adapted to control a rotation of the virtual three-dimensional object dependent on the change in shape and position of the touched region with time. Accordingly, rolling the thumb over the sensor panel translates to a rotation of the three-dimensional object displayed, i.e. if the finger rotates to the left, also the virtual three-dimensional object rotates to the left.

In FIG. 3a, the center position of the touched region has been used as an average position to explain the movement of the position in time. However, instead of the center position also other positions may be used to achieve the same effect. For example, the position of the upper left or upper right corner may be used which also moves slightly to the left (the negative x-direction) with time in FIG. 3a without changing its position in the y-direction.

Another example of a gesture that can be detected by the touch-sensitive input device 100, 100′ is explained with respect to FIG. 3b.

In FIG. 3b at time t₁ a fingertip is slightly touching the sensor panel so that the shape determined by the controller is basically a round circular shape and the position may be defined by the center position of the circular shape. If the finger moves down from its tip to the flat button surface of the upper section of the finger, i.e. the nail section, the flattening of the finger can be easily detected, since the region touched by the finger will be more elongated and oval, as can be seen at time t₂ in FIG. 3b, similar to the elongated rectangular shapes of FIG. 3a. Further, at t₃ in FIG. 3b, the finger moves back on its tip so that again a small round shape can be detected. By moving the finger from the tip to the upper section, it is also possible that the pressure exerted on the sensor panel increases so that the region touched by the finger further increases due to flattening through pressure increase.

It is noted that the actual shape, in particular, the “roundness” of the edges is dependent on the resolution of the sensor panel, wherein in FIG. 3a a lower resolution has been assumed as in FIG. 3b. However, for illustrative purposes, looking at the change in the rectangular shape in FIG. 3a better reveals the differences between the shapes detected at different times.

Further, it is noted that the center position shown in FIG. 3b does hardly change in x-direction with time, but when the finger goes down from its tip and flattens on the sensor panel at time t₂, the center position moved in the negative y-direction.

Similar to the discussion with respect to FIG. 3a, also the gesture described in FIG. 3b may be associated with one or more functions.

For example, when the controller is adapted to detect a finger of the user who increases the pressure, e.g. resulting in a flattening of the finger shown at time t₂, this can be determined by the controller by an increase in the size and change of position of the touched region with time, namely from time t₁ to time t₂. This gesture may be associated with selecting a virtual object, such as an icon or an image displayed on the display device 130. Thus, the controller controls the selection of a virtual object dependent on the change in shape and position of the touched region with time, as described with respect to FIG. 3b. Once a virtual object is selected, it may be lifted and moved with the finger by again moving the finger up on its tip, as shown at time t₃. Afterwards, it may be dropped at a different position.

Accordingly, the controller may be adapted to detect the finger of the user decreasing pressure on the sensor panel by determining a decrease in the size and change of position of the touched region with time, e.g. from time t₂ to time t₃.

For example, the whole gesture that may be associated with selecting and lifting a virtual object from a virtual surface to be moved at a different location of the surface, may be associated with placing the finger on the object and then laying the finger flat, and moving the finger back up on its tip so that the item lifts and can be moved.

In summary, the sensor panel 110 is operable to sense a region of the sensor panel that is touched by a finger of the user and the controller 120 is adapted to determine a finger motion, such as a rolling motion of the finger of the user, on the sensor panel so that a function that is associated with the finger motion may be triggered.

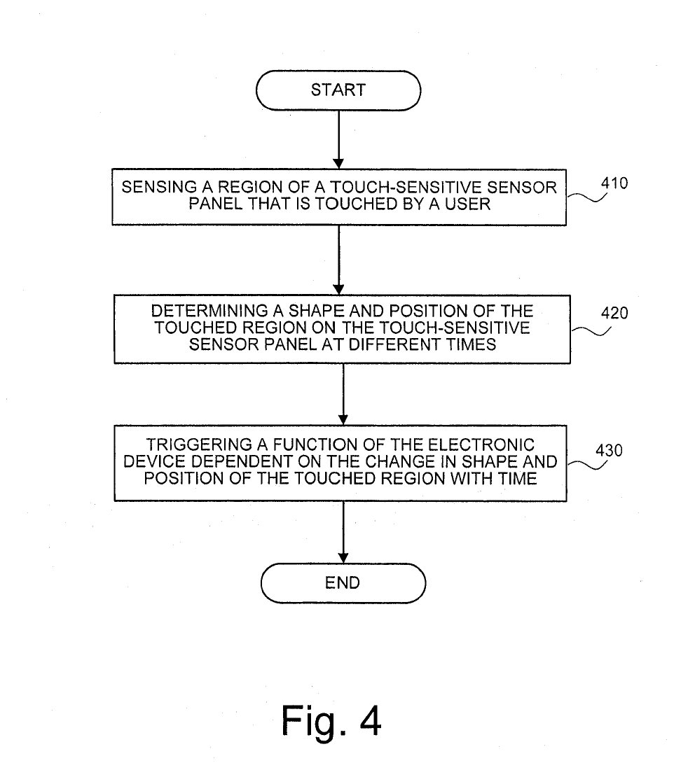

In the following, operations of a method for operating a touch-sensitive input device, such as the touch-sensitive input device 100 or 100′, will be described with respect to FIG. 4.

In a first step 410, a region touched by the user on the sensor panel is sensed. As described above, the region may be defined by the number of touch-sensitive elements that are covered by the finger and thus activated.

Further, in the step 420 a shape and position of the touched region on the sensor panel is determined at a first time, and after a certain time interval, the shape and position of the touched region is determined at a second time. Accordingly, shape and position can be determined at different times, whereas the detection of a gesture of a finger can be made more accurate.

In this way, spatial resolution of the touch-sensitive elements resulting in a good approximation of the shape as well as high resolution in time, i.e. several determinations at short time intervals, such as 0.1 seconds, lead to the differentiation of several different gestures. Once a gesture is detected using the changes in shape and position of the touched region with time, a function corresponding to the gesture can be triggered.

In other words, as shown in step 430, a function of the electronic device, such as a mobile phone, is triggered dependent on a change in shape and position of the touched region with time.

Therefore, several new gestures may be created to navigate three-dimensional interfaces, such as turning three-dimensional objects 530 shown in FIG. 5, which will be described in more detail in the following.

FIG. 5 illustrates schematically a mobile device displaying a virtual three-dimensional object that can be moved by gestures. The mobile device may be a mobile phone comprising a speaker and a microphone and a touch screen display 510 as well as other elements (not shown) that are usually contained in a mobile phone.

The touch screen display 510 may be constituted by the touch-sensitive input device 100, 100′ including a display device displaying the three-dimensional object 530, which may be called a triad, since it comprises three faces, wherein each face may comprise one or more icons or objects 550.

For example, the object 550 may be an image displayed on the one face of the triad 530. For example, this image may be selected using the gesture described with respect to FIG. 3b to be lifted and moved to a different place on the touch screen display 510.

Further, by using the gesture described with respect to FIG. 3a the triad 530 may be rotated so that the side face shown in FIG. 5 becomes the front face. Then, objects of the front face may be selected and moved. Using this concept, it is possible to present more information, such as images, to a user on a screen and the user is enabled to easily flip through different images. Similarly, the object 550 may also be a menu so that several menus are quickly accessible by just rotating a finger on the touch screen display 510. Accordingly, operating a touch screen display 510 and navigating through menus is simplified.

The above description has mentioned several individual elements, such as the controller 120 and the touch-sensitive sensor panel 110, and it should be understood that the invention is not limited to these elements being independent structural units but these elements should be understood as elements comprising different functions. In other words, it is understood by the skilled person that an element in the above-described embodiments should not be construed as being limited to a separate tangible part but is understood as a kind of functional entity so that several functions may also be provided in one tangible entity or even when an element, such as the controller performs several functions, these functions may be distributed to different parts, for example to a means for determining a shape and a position and a means for triggering a function.

Moreover, physical entities according to the invention and/or its embodiments and examples may comprise storing computer program including instructions such that, when the computer programs are executed on the physical entities, such as the controller including a processor, CPU or similar, steps, procedures and functions of these elements are carried out according to embodiments of the invention.

For example, specifically programmed software may be used to be run on a processor, e.g. contained in the controller, to control the above-described functions, e.g. the functions described in the steps of FIG. 4.

In this context, it is noted that the invention also relates to computer programs for carrying out functions of the elements, such as the method steps described with respect to FIG. 4, wherein the computer programs may be stored in a memory connected to the controller 120 or integrated in the controller 120.

The above-described elements of the touch-sensitive sensor panels 100 and 100′ may be implemented in hardware, software, field-programmable gate arrays (FPGAs), application specific integrated circuits (ASICs), firmware or the like or combinations thereof.

It will be appreciated that various modifications and variations can be made in the described elements, touch-sensitive sensor panels, mobile devices and methods as well as in the construction of this invention without departing from the scope of spirit of the invention. The invention has been described in a relation to particular embodiments which are intended in all aspects to be illustrative rather than restrictive. Those skilled in the art will appreciate that many different combinations of hardware, software and firmware are suitable for practising the invention.

Moreover, other implementations of the invention will be apparent to the skilled person from consideration of the specification and practice of the invention disclosed herein.

It is intended that the specification and the examples are considered as exemplary only. To this end, it is to be understood that inventive aspects may lie in less than all features of the single foregoing disclosed implementation or configuration. Thus, the true scope and spirit of the invention is indicated by the following claims.

1. Touch-sensitive input device for an electronic device, comprising
a touch-sensitive sensor panel operable to sense a region of said touch-sensitive sensor panel that is touched by a user; and
a controller adapted to determine a shape and position of the touched region on said touch-sensitive sensor panel at different times and adapted to trigger a function of the electronic device dependent on the change in shape and position of the touched region with time.

2. Touch-sensitive input device of claim 1, wherein said touch-sensitive sensor panel has a plurality of touch-sensitive elements activatable by the user and activated touch-sensitive elements define the shape and position of said touched region.

3. Touch-sensitive input device of claim 2, wherein said touch-sensitive elements comprise at least one of resistive and capacitive touch-sensitive elements.

4. Touch-sensitive input device of claim 1, wherein said controller is adapted to determine the center position of said touched region.

5. Touch-sensitive input device of claim 1, wherein said controller is adapted to detect a finger of said user rolling over said touch-sensitive sensor panel by determining a change in the size and of position of said touched region with time.

6. Touch-sensitive input device of claim 1, wherein said controller is adapted to detect a finger of said user increasing pressure on said touch-sensitive sensor panel by determining an increase in the size and change of position of said touched region with time.

7. Touch-sensitive input device of claim 1, wherein said controller is adapted to detect a finger of said user decreasing pressure on said touch-sensitive sensor panel by determining a decrease in the size and change of position of said touched region with time.

8. Touch-sensitive input device of claim 1, further comprising a display device.

9. Touch-sensitive input device of claim 8, wherein said controller is adapted to control a rotation of a virtual three-dimensional object displayed on said display device dependent on the change in shape and position of the touched region with time.

10. Touch-sensitive input device of claim 8, wherein said controller is adapted to control the selection of a virtual object displayed on said display device dependent on the change in shape and position of the touched region with time.

11. Touch-sensitive input device for an electronic device, comprising
a touch-sensitive sensor panel operable to sense a region of said touch-sensitive sensor panel that is touched by a finger of a user; and
a controller adapted to determine a finger rolling motion by the finger of the user on the touch-sensitive sensor panel.

12. Mobile device comprising said touch-sensitive input device of claim 1.

13. Mobile device of claim 12, wherein said mobile device constitutes a mobile phone with a touch screen display.

14. Touch-sensitive input device of an electronic device, comprising
means for sensing a region of a touch-sensitive sensor panel that is touched by a user;
means for determining a shape and position of the touched region on said touch-sensitive sensor panel at different times; and
means for triggering a function of the electronic device dependent on the change in shape and position of the touched region with time.

15. Method for operating a touch-sensitive input device of an electronic device, comprising the steps of
sensing a region of a touch-sensitive sensor panel that is touched by a user;
determining a shape and position of the touched region on said touch-sensitive sensor panel at different times; and
triggering a function of the electronic device dependent on the change in shape and position of the touched region with time.
